(19) United States
(12) Patent Application Publication
(10) Pub. No.: US 2025/0075030 A1
(43) Pub. Date: Mar. 6, 2025

(54) RESIN COMPOSITION, RESIN SHEET, CONDUCTOR-LAYER-INCLUDED RESIN SHEET, MULTILAYER SUBSTRATE, AND METHOD FOR MANUFACTURING RESIN SHEET

(71) Applicant: Murata Manufacturing Co., Ltd., Nagaokakyo-shi (JP)

(72) Inventor: Yuki ROKUSHA, Nagaokakyo-shi (JP)

(21) Appl. No.: 18/952,524

(22) Filed: Nov. 19, 2024

Related U.S. Application Data
(63) Continuation of application No. PCT/JP2023/021829, filed on Jun. 13, 2023.

(30) Foreign Application Priority Data
Jul. 1, 2022 (JP) 2022-107081

(51) Int. Cl. C08G 63/06; C08J 5/18; C08K 3/013; C08K 9/04

(52) U.S. Cl. CPC C08G 63/065; C08J 5/18; C08K 3/013; C08K 9/04; C08G 2250/00; C08J 2367/06; C08K 2201/003; C08K 2201/005; C08K 2201/006; C08K 2201/016

(57) ABSTRACT

A resin composition that includes: a resin component having a liquid crystal polymer as a primary component thereof; and an inorganic filler, wherein a specific surface area of the inorganic filler is 30 m²/cm³ or less, a maximum diameter of the inorganic filler is 100 μm or less, and a content of the inorganic filler is 0.1% by volume to 60% by volume.

### CROSS REFERENCE TO RELATED APPLICATIONS

The present application is a continuation of International application No. PCT/JP2023/021829, filed Jun. 13, 2023, which claims priority to Japanese Patent Application No. 2022-107081, filed Jul. 1, 2022, the entire contents of each of which are incorporated herein by reference.

### TECHNICAL FIELD

The present disclosure relates to a resin composition, a resin sheet, a conductor-layer-included resin sheet, a multilayer substrate, and a method for manufacturing a resin sheet.

### BACKGROUND ART

Patent Document 1 discloses a resin composition in which (A) a synthetic resin having a melting temperature of 300° C. or higher includes (B) a tabular inorganic filler having characteristics of water dispersion pH: 5.5 to 8.0, amount of eluted alkali of Na: 30 ppm or less and K: 40 ppm or less, maximum diameter a: 50 μm or less, thickness b: 1.0 μm or less, and aspect ratio (a/b): 20 or more. Patent Document 1 discloses a liquid crystal polymer as a specific example of the synthetic resin having a melting temperature of 300° C. or higher.

Patent Document 2 discloses a liquid crystalline polyester resin composition containing (B) 10 to 80 parts by weight of tabular filler relative to (A) 100 parts by weight of liquid crystalline polyester resin, wherein a melting point of the liquid crystalline polyester resin in the liquid crystalline polyester resin composition is 300° C. or higher and lower than 330° C., and a deflection temperature under load of a molded article produced by molding the liquid crystalline polyester resin composition measured in conformity with ASTM D648 is 260° C. or higher and lower than 285° C.

Patent Document 3 discloses a method for manufacturing a liquid crystal polymer film including a filler, the method including a step of obtaining a powder mixture of a liquid crystal polymer and a filler; a step of forming a multilayer body including a layer of the powder mixture between two film-like heat-resistant base materials; and a step of heat-compression-molding the multilayer body between a pair of heating rolls.
Patent Document 1: International Publication No. 01/40380
Patent Document 2: Japanese Unexamined Patent Application Publication No. 2016-89154
Patent Document 3: Japanese Unexamined Patent Application Publication No. 2014-111699

### SUMMARY OF THE DISCLOSURE

Liquid crystal polymer sheets have low permittivity and, therefore, are known as members to improve the dielectric characteristics in high frequency regions of multilayer substrates used for various types of electronic equipment. On the other hand, to produce a low-profile multilayer substrate, the liquid crystal polymer sheet is required to be thinned.

In this regard, to obtain a thinned liquid crystal polymer sheet, the present inventor investigated molding of a resin composition containing a liquid crystal polymer into the shape of a sheet by a melt extrusion method.

However, according to the investigation by the present inventor, it was found that when the resin composition including a liquid crystal polymer and a filler, as described in Patent Document 1 and Patent Document 2, was molded into the shape of a sheet by a melt extrusion method, the resin composition was broken during molding since the melt tension of the resin composition was low due to presence of the filler and, as a result, molding into the shape of a sheet was difficult.

Further, according to the investigation by the present inventor, it was found that when the resin composition including a liquid crystal polymer and a filler is molded into the shape of a sheet by the method described in Patent Document 3, the molding itself of the resin composition into the shape of a sheet is possible, but since there is a step of pulverization after kneading of a molten liquid crystal polymer and a filler in the middle of the process, so-called contamination occurs, where foreign matter (for example, metal) resulting from a pulverizer and the like used in the step is mixed into an obtained liquid crystal polymer sheet.

The present disclosure was realized to address the above-described problem and is intended to provide a resin composition capable of being molded into the shape of a sheet by the melt extrusion method. In addition, the present disclosure is intended to provide a resin sheet composed of the above-described resin composition, a conductor-layer-included resin sheet including the above-described resin sheet, and a multilayer substrate including the above-described conductor-layer-included resin sheet. Further, the present disclosure is intended to provide a method for manufacturing a resin sheet, the method being capable of molding the resin composition into the shape of a sheet by a melt extrusion method without causing contamination.

A resin composition according to the present disclosure includes: a resin component comprising a liquid crystal polymer as a primary component thereof; and an inorganic filler, wherein a specific surface area of the inorganic filler is 30 m²/cm³ or less, a maximum diameter of the inorganic filler is 100 μm or less, and a content of the inorganic filler is 0.1% by volume to 60% by volume.

A resin sheet according to the present disclosure is composed of a resin composition according to the present disclosure.

A conductor-layer-included resin sheet according to the present disclosure includes the resin sheet according to the present disclosure and a conductor layer adjoining at least one principal surface of the resin sheet.

A multilayer substrate according to the present disclosure includes the conductor-layer-included resin sheet according to the present disclosure.

A method for manufacturing a resin sheet according to the present disclosure includes: preparing a resin composition that includes (1) a resin component comprising a liquid crystal polymer as a primary component thereof and (2) an inorganic filler having a specific surface area of 30 m²/cm³ or less and a maximum diameter of 100 μm or less, wherein a content of the inorganic filler is 0.1% by volume to 60% by volume in the resin composition; and molding the resin composition into a sheet by melt extrusion.

According to the present disclosure, a resin composition capable of being molded into the shape of a sheet by a melt extrusion method can be provided. In addition, according to the present disclosure, a resin sheet composed of the above-described resin composition, a conductor-layer-included resin sheet including the above-described resin sheet, and a multilayer substrate including the above-described conductor-layer-included resin sheet can be provided. Further, according to the present disclosure, a method for manufacturing a resin sheet, the method being capable of molding the resin composition into the shape of a sheet by a melt extrusion method without causing contamination can be provided.

### BRIEF DESCRIPTION OF THE DRAWINGS

FIG. 1 is a schematic sectional view illustrating an example of a resin sheet according to the present disclosure.

FIG. 2 is a schematic sectional view illustrating an example of the resin sheet according to the present disclosure, the example differing from FIG. 1.

FIG. 3 is a schematic sectional view illustrating an example of the resin sheet according to the present disclosure, the example differing from FIG. 1 and FIG. 2.

FIG. 4 is a schematic sectional view illustrating an example of a conductor-layer-included resin sheet according to the present disclosure.

FIG. 5 is a schematic sectional view illustrating an example of a multilayer substrate according to the present disclosure.

FIG. 6 is a schematic sectional view illustrating a step of producing a conductor-layer-included resin sheet in an example of a method for manufacturing a multilayer substrate according to the present disclosure.

FIG. 7 is a schematic sectional view illustrating a step of producing a conductor-layer-included resin sheet in an example of the method for manufacturing a multilayer substrate according to the present disclosure.

FIG. 8 is a schematic sectional view illustrating a step of producing a conductor-layer-included resin sheet in an example of the method for manufacturing a multilayer substrate according to the present disclosure.

FIG. 9 is a schematic sectional view illustrating a step of forming a via hole in an example of the method for manufacturing a multilayer substrate according to the present disclosure.

FIG. 10 is a schematic sectional view illustrating a step of forming a via hole in an example of the method for manufacturing a multilayer substrate according to the present disclosure.

FIG. 11 is a schematic sectional view illustrating a step of introducing a conductive paste in an example of the method for manufacturing a multilayer substrate according to the present disclosure.

FIG. 12 is a schematic sectional view illustrating a step of introducing a conductive paste in an example of the method for manufacturing a multilayer substrate according to the present disclosure.

FIG. 13 is a schematic sectional view illustrating a step of forming an interlayer connection conductor in an example of the method for manufacturing a multilayer substrate according to the present disclosure.

### DESCRIPTION OF THE PREFERRED EMBODIMENTS

A resin composition according to the present disclosure, a resin sheet according to the present disclosure, a conductor-layer-included resin sheet according to the present disclosure, a multilayer substrate according to the present disclosure, and a method for manufacturing a resin sheet according to the present disclosure will be described below. In this regard, the present disclosure is not limited to the following configurations and may be appropriately modified within a range of not departing from the scope of the present disclosure. In addition, a combination of a plurality of individual favorable configurations described below is also included in the present disclosure.

The resin composition according to the present disclosure includes a liquid crystal polymer and an inorganic filler, wherein a specific surface area of the inorganic filler is 30 m²/cm³ or less, a maximum diameter of the inorganic filler is 100 μm or less, and a content of the inorganic filler is 0.1% by volume to 60% by volume.

The resin composition according to the present disclosure includes a liquid crystal polymer and an inorganic filler.

The resin composition according to the present disclosure including a liquid crystal polymer enables the lowering of the permittivity of the resin sheet composed of the resin composition. Consequently, the resin composition according to the present disclosure can improve the dielectric characteristics in high frequency regions of the multilayer substrate including the resin sheet composed of the resin composition according to the present disclosure.

In the resin composition according to the present disclosure, it is preferable that the liquid crystal polymer contain a copolymer of p-hydroxybenzoic acid (HBA) and 6-hydroxy-2-naphthoic acid (HNA).

In general, the copolymer of p-hydroxybenzoic acid and 6-hydroxy-2-naphthoic acid is referred to as a type II wholly aromatic polyester (also referred to as type 1.5 wholly aromatic polyester). The type II wholly aromatic polyester does not readily undergo hydrolysis compared with a type III semi-aromatic polyester and, therefore, is suitable for a material to constitute the multilayer substrate. In addition, the type II wholly aromatic polyester has a small dielectric loss tangent due to being derived from a naphthalene ring and, therefore, contributes to reduction in electric energy loss of the resin sheet in the multilayer substrate.

In the resin composition according to the present disclosure, the liquid crystal polymer may further contain a type I wholly aromatic polyester in addition to the type II wholly aromatic polyester, may further contain the type III semi-aromatic polyester, or may further contain the type I wholly aromatic polyester and the type III semi-aromatic polyester.

The structure (type) of each monomer constituting the liquid crystal polymer can be analyzed by a reactive pyrolysis gas chromatography mass spectrometry (reactive pyrolysis GC-MS method).

In the resin composition according to the present disclosure, when the liquid crystal polymer contains a copolymer of p-hydroxybenzoic acid and 6-hydroxy-2-naphthoic acid, the molar ratio of p-hydroxybenzoic acid to 6-hydroxy-2-naphthoic acid is preferably 0.20 to 5.

In the liquid crystal polymer, when the molar ratio of p-hydroxybenzoic acid to 6-hydroxy-2-naphthoic acid is less than 0.20 or more than 5, the melting point of the resin composition may be higher than a preferable range described later.

In the resin composition according to the present disclosure, when the liquid crystal polymer contains a copolymer of p-hydroxybenzoic acid and 6-hydroxy-2-naphthoic acid, the liquid crystal polymer contains preferably 10% by mole or more of each of p-hydroxybenzoic acid and 6-hydroxy-2-naphthoic acid, where a total amount of monomers is set to be 100% by mole.

When the content of each monomer of p-hydroxybenzoic acid and 6-hydroxy-2-naphthoic acid is less than 10% by mole in the liquid crystal polymer, neither exertion of liquid crystallinity of the liquid crystal polymer nor the melting point of the resin composition becoming within a preferable range described below nor reduction in the dielectric loss tangent of the liquid crystal polymer may be readily realized.

The ratio and the content of each monomer constituting the liquid crystal polymer can be analyzed by a reactive pyrolysis gas chromatography mass spectrometry.

The resin composition according to the present disclosure contains the liquid crystal polymer as a resin component. The resin component may contain a component other than the liquid crystal polymer provided that the liquid crystal polymer is contained as a primary component.

In the present specification, a primary component means a component with the largest weight percentage.

The resin composition according to the present disclosure including the inorganic filler enables the resin sheet composed of the resin composition according to the present disclosure to be provided with various characteristics described below.

The resin composition according to the present disclosure including an inorganic filler may impart heat dissipation ability to the resin sheet. When the resin sheet has heat dissipation ability, since the heat generated due to internal resistance of a constituent component is readily dissipated to the outside, the safety and the reliability of the multilayer substrate including the resin sheet, and consequently, electronic equipment in which the multilayer substrate is used tend to be improved.

Examples of the inorganic filler capable of imparting the heat dissipation ability include boron nitride, aluminum nitride, silicon carbide, alumina, talc, and metals. Of these, boron nitride is suitable for the inorganic filler capable of imparting the heat dissipation ability since the liquid crystal polymer is not readily decomposed.

The resin composition according to the present disclosure including the inorganic filler may impart high permittivity to the resin sheet. When the multilayer substrate including the resin sheet is used for an antenna component, the resin sheet having high permittivity facilitates the radio wave used by the antenna component becoming a shorter wavelength and, therefore, facilitates size reduction of the antenna component.

Examples of the inorganic filler capable of imparting high permittivity include titanium oxide, barium titanate, calcium titanate, and lead zirconate titanate. Of these, titanium oxide is suitable for the inorganic filler capable of imparting high permittivity since the liquid crystal polymer is not readily decomposed.

The resin composition according to the present disclosure including the inorganic filler may impart magnetism to the resin sheet. In the multilayer substrate including the resin sheet, the resin sheet having magnetism enables the resin sheet to block an electromagnetic wave from the outside (to absorb noise).

Examples of the inorganic filler capable of imparting magnetism include ferrite and metals. Of these, ferrite is suitable for the inorganic filler capable of imparting the magnetism since changes in the physical properties due to oxidation do not readily occur.

The resin composition according to the present disclosure including the inorganic filler may impart flame retardancy to the resin sheet. When the resin sheet has flame retardancy, the safety of the multilayer substrate including the resin sheet, and consequently, electronic equipment in which the multilayer substrate is used tends to be improved.

Examples of the inorganic filler capable of imparting flame retardancy include magnesium hydroxide, antimony oxide, aluminum hydroxide, zinc borate, molybdic acid compounds, tin oxide compounds, phosphoric compounds, iron oxide, cuprous oxide, and silica. Of these, magnesium hydroxide is preferable since a large effect of imparting the flame retardancy is exerted.

The resin composition according to the present disclosure may include a lightweight inorganic filler. When the multilayer substrate including the resin sheet is used for an automobile component, the inorganic filler in the resin composition being lightweight makes the resin sheet lightweight and, therefore, facilitates improvement of automobile fuel efficiency.

Examples of the inorganic filler capable of being lightweight include inorganic fillers having a hollow structure, such as hollow silica and hollow glass. Of these, hollow silica is suitable for the inorganic filler capable of being lightweight since the liquid crystal polymer is not readily decomposed.

In the resin composition according to the present disclosure, the inorganic filler may be subjected to surface treatment. That is, a surface treatment layer may be disposed on the surface of the inorganic filler in the resin composition according to the present disclosure. Accordingly, since the dispersibility of the inorganic filler in the resin composition is readily improved, the physical properties of the resin composition derived from the inorganic filler do not readily vary in accordance with the position in the resin composition.

Examples of the constituent material of the surface treatment layer include silane coupling agents, titanate coupling agents, phosphoric acid esters, fatty acids (for example, stearic acid and oleic acid).

In the resin composition according to the present disclosure, the specific surface area of the inorganic filler is 30 m²/cm³ or less.

Regarding the resin composition according to the present disclosure, since the specific surface area of the inorganic filler is 30 m²/cm³ or less and is small, intermolecular interaction and entanglement between liquid crystal polymers tend to remain, and thereby the melt tension of the resin composition is not readily decreased compared with the resin composition in which the specific surface area of the inorganic filler is more than 30 m²/cm³. That is, the resin composition according to the present disclosure tends to have high melt tension since the specific surface area of the inorganic filler is 30 m²/cm³ or less and is small. Therefore, when the resin composition according to the present disclosure is molded into the shape of a sheet by a melt extrusion method, the resin composition can endure tensile stress during molding. Consequently, the resin composition according to the present disclosure is not readily broken during molding to perform molding into the shape of a sheet by the melt extrusion method.

In the resin composition according to the present disclosure, the specific surface area of the inorganic filler is preferably 20 m²/cm³ or less.

In the resin composition according to the present disclosure, when the specific surface area of the inorganic filler is 20 m²/cm³ or less, the interface between the liquid crystal polymer and the inorganic filler tends to decrease, the amount of water captured at the interface between the liquid crystal polymer and the inorganic filler is thereby decreased, and, as a result, the water absorption of the resin sheet composed of the resin composition tends to be decreased.

In the resin composition according to the present disclosure, the specific surface area of the inorganic filler is preferably 0.1 m²/cm³ or more.

In the resin composition according to the present disclosure, when the specific surface area of the inorganic filler is less than 0.1 m²/cm³, it may be difficult to set the maximum diameter of the inorganic filler described later to be 100 μm or less.

A method for determining the specific surface area of the inorganic filler in a state of the resin composition is as described below. Initially, the inorganic filler is removed from the resin composition, and the inorganic filler is deaerated. Thereafter, the specific surface area of the inorganic filler is measured by the BET single point method. Specifically, the specific surface area of the inorganic filler is calculated from the amount of nitrogen gas adsorbed onto the surface of about 0.1 g to 1.0 g of weighed inorganic filler. When the specific surface area of the inorganic filler is measured, a specific surface area measuring device, such as Full Automatic Specific Surface Area Analyzer “Macsorb (registered trademark)” produced by Mountech Co., Ltd. is used. In this regard, when the specific surface area of the inorganic filler in a state of the resin sheet or the multilayer substrate described later is determined, the inorganic filler is removed from the target resin sheet, and the specific surface area of the inorganic filler is determined by the above-described method.

In the resin composition according to the present disclosure, the maximum diameter of the inorganic filler is 100 μm or less.

In the resin composition according to the present disclosure, when the resin composition according to the present disclosure is molded into the shape of a sheet by a melt extrusion method, since the maximum diameter of the inorganic filler is 100 μm or less and is small, the resulting resin sheet is not readily bored, and the resin sheet is not readily broken compared with the resin composition in which the maximum diameter of the inorganic filler is more than 100 μm.

In the resin composition according to the present disclosure, the maximum diameter of the inorganic filler is preferably 1 μm or more.

In the resin composition according to the present disclosure, when the maximum diameter of the inorganic filler is less than 1 μm, it may be difficult to set the above-described specific surface area of the inorganic filler to be 30 m²/cm³ or less.

A method for determining the maximum diameter of the inorganic filler in a state of the resin composition is as described below. Initially, the inorganic filler is removed from the resin composition, and the inorganic filler is subjected to ultrasonic dispersion in ethanol. Thereafter, the particle size distribution of the inorganic filler is measured by a laser diffraction/scattering method. In such an instance, the particle diameter of the inorganic filler is measured as an equivalent circle diameter. When the particle size distribution of the inorganic filler is measured, a laser diffraction/scattering particle size distribution measuring device, such as Laser Diffraction/Scattering Particle Size Distribution Analyzer “LA-960” produced by HORIBA, Ltd. is used. Then, the maximum particle diameter in the obtained particle size distribution of the inorganic filler is determined as the maximum diameter of the inorganic filler. In this regard, when the maximum diameter of the inorganic filler in a state of the resin sheet or the multilayer substrate described later is determined, the inorganic filler is removed from the target resin sheet, and the maximum diameter of the inorganic filler is determined by the above-described method.

In the resin composition according to the present disclosure, the content of the inorganic filler is 0.1% by volume to 60% by volume.

In the resin composition according to the present disclosure, since the content of the inorganic filler is 0.1% by volume to 60% by volume, the melt tension of the resin composition is not readily decreased. That is, the resin composition according to the present disclosure tends to have high melt tension since the content of the inorganic filler is 0.1% by volume to 60% by volume, and, in addition, the above-described characteristics imparted by the inorganic filler tend to be realized. Therefore, when the resin composition according to the present disclosure is molded into the shape of a sheet by a melt extrusion method, the resin composition can endure tensile stress during molding. Consequently, the resin composition according to the present disclosure is not readily broken during molding to perform molding into the shape of a sheet by the melt extrusion method.

In the resin composition according to the present disclosure, when the content of the inorganic filler is less than 0.1% by volume, the above-described characteristics imparted by the inorganic filler are not readily realized. Regarding the resin composition according to the present disclosure, for example, the flame retardancy can be imparted to the resin sheet even when the content of the inorganic filler is 0.1% by volume and is low.

In the resin composition according to the present disclosure, when the content of the inorganic filler is more than 60% by volume, since the melt tension of the resin composition is readily decreased, the resin composition according to the present disclosure is readily broken during molding to perform molding into the shape of a sheet by the melt extrusion method.

A method for determining the content of the inorganic filler in a state of the resin composition is as described below. Initially, a simultaneous thermogravimetry-differential thermal analysis (TG-DTA) device is used, and a resin component (liquid crystal polymer or the like) in the resin composition is completely thermally decomposed by, for example, increasing the temperature of the resin composition to 600° C. and leaving the resin composition to stand for 45 min at 600° C. Subsequently, the content of the inorganic filler in the resin composition is calculated from the volume (weight) of the inorganic filler left after the resin component is removed. In this regard, when the content of the inorganic filler in a state of the resin sheet or the multilayer substrate described later is determined, the measurement target may be changed from the resin composition to the resin sheet in the above-described method.

As described above, according to the resin composition of the present disclosure, even in a complex state of including the liquid crystal polymer and the inorganic filler, the resin composition capable of being molded into the shape of a sheet by the melt extrusion method can be realized by satisfying all the specific surface area of the inorganic filler being 30 m²/cm³ or less, the maximum diameter of the inorganic filler being 100 μm or less, and the content of the inorganic filler being 0.1% by volume to 60% by volume.

In the resin composition according to the present disclosure, it is preferable that the inorganic filler be tabular.

In general, regarding the resin composition in a complex state of including the liquid crystal polymer and the inorganic filler, since the orientation of the liquid crystal polymer tends to deteriorate due to presence of the inorganic filler, when the resin composition is molded into the shape of a sheet so as to form a resin sheet, the tensile elongation at break of the resin sheet tends to decrease. On the other hand, when the inorganic filler is tabular, the orientation of the liquid crystal polymer in the resin composition does not readily deteriorate. Therefore, when the resin composition is molded into the shape of a sheet so as to form a resin sheet, the tensile elongation at break of the resin sheet does not readily decrease.

In the present specification, the tabular means a shape, such as boron nitride or talc, spreading in an in-plane direction orthogonal to the thickness direction.

In this regard, in the resin composition according to the present disclosure, the shape of inorganic filler may be, for example, spherical other than tabular.

In the resin composition according to the present disclosure, the average particle diameter of the inorganic filler is preferably 0.1 μm to 30 μm.

A method for determining the average particle diameter of the inorganic filler in a state of the resin composition is as described below. Initially, the cumulative particle size distribution of the inorganic filler on a volume basis is determined by converting the particle size distribution of the inorganic filler obtained in determination of the maximum diameter of the inorganic filler to the particle size distribution expressed in the cumulative probability. Subsequently, a median diameter D₅₀ (particle diameter at the cumulative probability of 50%) is determined from the obtained cumulative particle size distribution of the inorganic filler on a volume basis, and the median diameter D₅₀ is determined as the average particle diameter of the inorganic filler. In this regard, when the average particle diameter of the inorganic filler in a state of the resin sheet or the multilayer substrate described later is determined, the inorganic filler is removed from the target resin sheet, and the average particle diameter of the inorganic filler is determined by the above-described method.

In the resin composition according to the present disclosure, the thickness of the inorganic filler is preferably 1 nm to 1000 nm.

A method for determining the thickness of the inorganic filler in a state of the resin composition is as described below. Initially, the inorganic filler is removed from the resin composition, and an image of the inorganic filler is picked up by using a scanning electron microscope (SEM). Subsequently, the resulting image of the inorganic filler is subjected to image analysis by using analysis software or the like so that the dimension of the inorganic filler in the short side direction (direction in which the dimension is the smallest) is measured. Herein, 100 inorganic fillers are subjected to the dimension measurement in the short side direction, and an average value of the obtained 100 measurement values is determined as the thickness of the inorganic filler. In this regard, when the thickness of the inorganic filler in a state of the resin sheet or the multilayer substrate described later is determined, the inorganic filler is removed from the target resin sheet, and the thickness of the inorganic filler is determined by the above-described method.

In the resin composition according to the present disclosure, the aspect ratio of the inorganic filler is preferably 2 to 100.

A method for determining the aspect ratio of the inorganic filler in a state of the resin composition is as described below. Initially, the inorganic filler is removed from the resin composition, and an image of the inorganic filler is picked up by using a scanning electron microscope. Subsequently, the resulting image of the inorganic filler is subjected to image analysis by using analysis software or the like so that the dimension of the inorganic filler in the short side direction and the dimension of the inorganic filler in the long side direction (direction in which the dimension is the largest) are measured. Herein, 100 inorganic fillers are subjected to the above-described dimension measurement in the short side direction and the long side direction, and B/A is determined as the aspect ratio of the inorganic filler where an average value of the 100 measurement values obtained as the dimension in the short side direction is denoted by A, and an average value of the 100 measurement values obtained as the dimension in the long side direction is denoted by B. In this regard, when the aspect ratio of the inorganic filler in a state of the resin sheet or the multilayer substrate described later is determined, the inorganic filler is removed from the target resin sheet, and the aspect ratio of the inorganic filler is determined by the above-described method.

In the resin composition according to the present disclosure, the average particle diameter of the inorganic filler is preferably 0.1 μm to 30 μm, the thickness of the inorganic filler is preferably 1 nm to 1000 nm, and the aspect ratio of the inorganic filler is preferably 2 to 100.

In the resin composition according to the present disclosure, the liquid crystal polymer is readily captured by the inorganic filler by satisfying all the average particle diameter of the inorganic filler being 0.1 μm to 30 μm, the thickness of the inorganic filler being 1 nm to 1000 nm, and the aspect ratio of the inorganic filler being 2 to 100. Therefore, when the resin composition is molded into the shape of a sheet so as to form a resin sheet, the coefficient of linear expansion of the resin sheet in the in-plane direction tends to decrease. When the resin sheet is used and the conductor-layer-included resin sheet or the multilayer substrate described later is formed, the coefficient of linear expansion of the resin sheet in the in-plane direction being small enables the coefficient of linear expansion of the resin sheet in the in-plane direction to approach the coefficient of linear expansion of the conductor layer (for example, copper foil) in the in-plane direction. As a result, regarding the conductor-layer-included resin sheet or the multilayer substrate, warping derived from a difference in the coefficient of linear expansion in the in-plane direction between the resin sheet and the conductor layer does not readily occur.

In the resin composition according to the present disclosure, the melt tension at a temperature 20° C. higher than the melting point of the resin composition is preferably 1.0 mN or more.

Regarding the resin composition according to the present disclosure, the melt tension at a temperature 20° C. higher than the melting point of the resin composition being 1.0 mN or more facilitates molding into the shape of a sheet by a melt extrusion method.

In the resin composition according to the present disclosure, the melt tension at a temperature 20° C. higher than the melting point of the resin composition is preferably 7.0 mN or less.

In the resin composition according to the present disclosure, when the melt tension at a temperature 20° C. higher than the melting point of the resin composition is higher than 7.0 mN, during molding to mold the resin composition into the shape of a sheet by the melt extrusion method, it is required to increase the tension to take up a molded article. When the tension to take up a molded article is increased as described above, variations may occur in thickness of the obtained resin sheet since it is difficult to maintain a constant speed of taking up the molded article.

The melting point of the resin composition is determined as described below. Initially, a differential scanning calorimeter is used, and the resin composition is completely melted by increasing the temperature. Regarding the differential scanning calorimeter, for example, Differential Scanning Calorimeter “DSC7000X” produced by Hitachi High-Tech Science Corporation is used. Subsequently, the temperature of the obtained melt is decreased and thereafter increased again. Herein, the temperature corresponding to an endothermic peak observed during the temperature increase is determined as the melting point of the resin composition. In this regard, when an endothermic peak is not readily observed in the above-described method, the melting point of the resin composition is determined by texture observation with a polarizing microscope under the crossed-Nicol condition. In this regard, when the melting point of the resin composition in a state of the resin sheet or the multilayer substrate described later is determined, the measurement target may be changed from the resin composition to the resin sheet in the above-described method.

The melt tension of the resin composition at a temperature 20° C. higher than the melting point of the resin composition is measured by using a melt tension measuring device at a temperature 20° C. higher than the melting point of the resin composition specified in the above-described method. Regarding the melt tension measuring device, for example, Capilograph (registered trademark) “F-1” produced by Toyo Seiki Seisaku-sho, Ltd. is used. In this regard, when the melt tension of the resin composition at a temperature 20° C. higher than the melting point of the resin composition in a state of the resin sheet or the multilayer substrate described later is determined, the measurement target may be changed from the resin composition to the resin sheet in the above-described method.

The melting point of the resin composition according to the present disclosure is preferably 275° C. to 330° C.

When the melting point of the resin composition according to the present disclosure is lower than 275° C., the heat resistance of the resin sheet may be insufficient for incorporating the multilayer substrate including the resin sheet composed of the resin composition according to the present disclosure into electronic equipment by reflow soldering.

When the melting point of the resin composition according to the present disclosure is higher than 330° C., since a higher working temperature is required for molding the resin composition according to the present disclosure into the shape of a sheet, deterioration of the liquid crystal polymer contained in the resin composition according to the present disclosure may be facilitated.

The resin sheet according to the present disclosure is composed of the resin composition according to the present disclosure.

In the present specification, sheet is synonymous with film, and the two are not distinguished from each other by the thickness.

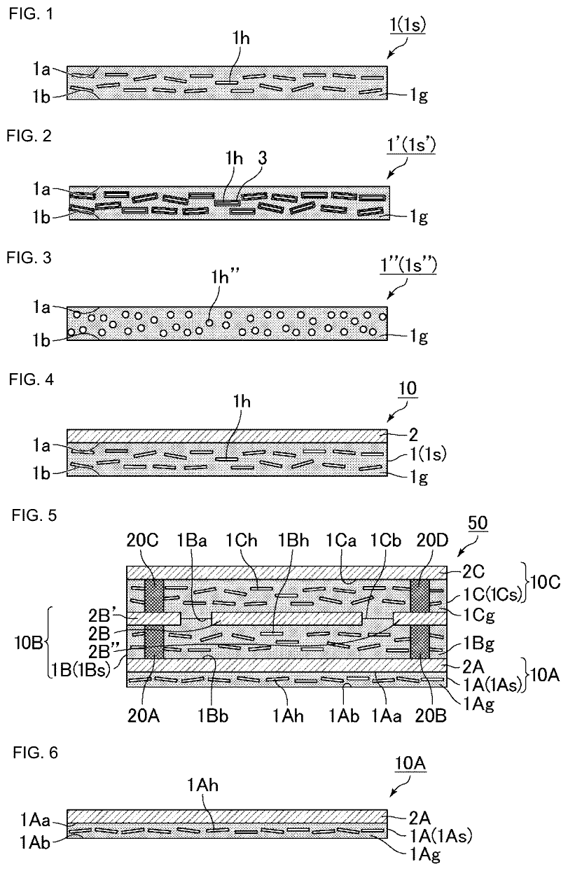

FIG. 1 is a schematic sectional view illustrating an example of the resin sheet according to the present disclosure.

A resin sheet 1 illustrated in FIG. 1 has a first principal surface 1a and a second principal surface 1b opposite each other in the thickness direction.

The thickness of the resin sheet 1 is preferably 10 μm to 250 μm.

The resin sheet 1 is composed of a resin composition 1s including a liquid crystal polymer 1g and an inorganic filler 1h.

The resin composition is corresponds to the resin composition according to the present disclosure.

The features of the liquid crystal polymer 1g are akin to the features of the liquid crystal polymer included in the above-described resin composition according to the present disclosure.

The features of the inorganic filler 1h are akin to the features of the inorganic filler included in the above-described resin composition according to the present disclosure. That is, in the resin sheet 1, indispensable features of the inorganic filler 1h are the specific surface area of the inorganic filler 1h being 30 m²/cm³ or less, the maximum diameter of the inorganic filler 1h being 100 μm or less, and the content of the inorganic filler 1h being 0.1% by volume to 60% by volume.

As illustrated in FIG. 1, it is preferable that the inorganic filler 1h be tabular. In such an instance, even when the resin sheet 1 includes the inorganic filler 1h, since the orientation of the liquid crystal polymer 1g does not readily deteriorate, the tensile elongation at break of the resin sheet 1 does not readily decrease.

As illustrated in FIG. 1, when the inorganic filler 1h is tabular, it is preferable that the inorganic filler 1h be oriented in the in-plane direction of the resin sheet 1. In such an instance, since the coefficient of linear expansion of the resin sheet 1 in the in-plane direction tends to decrease, when the resin sheet 1 is used and the conductor-layer-included resin sheet or the multilayer substrate described later is formed, the coefficient of linear expansion of the resin sheet 1 in the in-plane direction can be approached the coefficient of linear expansion of the conductor layer (for example, copper foil) in the in-plane direction. As a result, regarding the conductor-layer-included resin sheet or the multilayer substrate, warping derived from a difference in the coefficient of linear expansion in the in-plane direction between the resin sheet 1 and the conductor layer does not readily occur.

The state in which the inorganic filler is oriented in the in-plane direction of the resin sheet means a state in which it can be said that the orientation direction of the inorganic filler is substantially parallel to the in-plane direction of the resin sheet when the entire resin sheet is viewed, and it is not necessary that the orientation direction of the inorganic filler is strictly parallel to the in-plane direction of the resin sheet.

As illustrated in FIG. 1, it is preferable that the inorganic filler 1h not be aggregated. In such an instance, the physical properties of the resin sheet 1 derived from the inorganic filler 1h do not readily vary in accordance with the position in the resin sheet 1.

As illustrated in FIG. 1, it is preferable that the amount of the inorganic filler 1h be small in a neighborhood region of the first principal surface 1a of the resin sheet 1, and it is more preferable that the inorganic filler 1h not be present in a neighborhood region of the first principal surface 1a of the resin sheet 1. In such an instance, in the conductor-layer-included resin sheet or the multilayer substrate described later, even when the conductor layer (for example, copper foil) adjoins the first principal surface 1a of the resin sheet 1, the adhesion between the resin sheet 1 and the conductor layer is suppressed from deteriorating due to the inorganic filler 1h.

As illustrated in FIG. 1, it is preferable that the amount of the inorganic filler 1h be small in a neighborhood region of the second principal surface 1b of the resin sheet 1 in addition to the neighborhood region of the first principal surface 1a of the resin sheet 1, and it is more preferable that the inorganic filler 1h not be present in a neighborhood region of the second principal surface 1b of the resin sheet 1.

That is, it is preferable that the amount of the inorganic filler 1h be small in a neighborhood region of at least one of the first principal surface 1a and the second principal surface 1b of the resin sheet 1, and it is more preferable that the inorganic filler 1h not be present in a neighborhood region of at least one of the first principal surface 1a and the second principal surface 1b of the resin sheet 1.

In the present specification, a neighborhood region of the first principal surface of the resin sheet means a region between the first principal surface and a first neighborhood position, where the first neighborhood position is a position at a shorter distance from the first principal surface between a position at a distance of one-fifth the thickness of the resin sheet from the first principal surface in the thickness direction and a position at a distance of 5 μm from the first principal surface in the thickness direction. A neighborhood region of the second principal surface of the resin sheet means a region between the second principal surface and a second neighborhood position, where the second neighborhood position is a position at a shorter distance from the second principal surface between a position at a distance of one-fifth the thickness of the resin sheet from the second principal surface in the thickness direction and a position at a distance of 5 μm from the second principal surface in the thickness direction.

FIG. 2 is a schematic sectional view illustrating an example of the resin sheet according to the present disclosure, the example differing from FIG. 1.

A resin sheet 1′ illustrated in FIG. 2 is composed of a resin composition 1s′ including the liquid crystal polymer 1g and the inorganic filler 1h.

In the resin sheet 1′, the inorganic filler 1h is subjected to surface treatment. More specifically, regarding the resin sheet 1′, a surface treatment layer 3 is disposed on the surface of the inorganic filler 1h.

FIG. 3 is a schematic sectional view illustrating an example of the resin sheet according to the present disclosure, the example differing from FIG. 1 and FIG. 2.

A resin sheet 1″ illustrated in FIG. 3 is composed of a resin composition 1s″ including the liquid crystal polymer 1g and an inorganic filler 1h″.

In the resin sheet 1″, the inorganic filler 1h″ is spherical.

A method for manufacturing the resin sheet according to the present disclosure includes preparing a resin composition that includes a liquid crystal polymer and an inorganic filler having a specific surface area of 30 m²/cm³ or less and a maximum diameter of 100 μm or less and that has a content of the inorganic filler of 0.1% by volume to 60% by volume and molding the resin composition into the shape of a sheet by a melt extrusion method.

### <Step of Preparing Resin Composition>

A resin composition that includes a liquid crystal polymer and an inorganic filler having a specific surface area of 30 m²/cm³ or less and a maximum diameter of 100 μm or less and that has a content of the inorganic filler of 0.1% by volume to 60% by volume, that is, the resin composition according to the present disclosure, is prepared. In such an instance, the resin composition in a molten state may be prepared by melt-kneading the liquid crystal polymer and the inorganic filler by using, for example, a twin screw extruder.

<Step of Molding Resin Composition into Shape of Sheet>

The resin composition is molded into the shape of a sheet by a melt extrusion method. In such an instance, the resin composition may be molded into the shape of a sheet by, for example, ejecting the resin composition in a molten state from a T die and, thereafter, performing cooling.

Consequently, the resin sheet according to the present disclosure is produced.

According to the method for manufacturing the resin sheet of the present disclosure, since the pulverization step described in Patent Document 3 is unnecessary after kneading of the molten liquid crystal polymer and the inorganic filler, the resin composition can be molded into the shape of a sheet by the melt extrusion method without causing contamination.

The resin composition used in the above-described manufacturing method is a resin composition that includes a liquid crystal polymer and an inorganic filler having a specific surface area of 30 m²/cm³ or less and a maximum diameter of 100 μm or less and that has a content of the inorganic filler of 0.1% by volume to 60% by volume, that is, the resin composition according to the present disclosure. Therefore, according to the above-described manufacturing method, a resin sheet molded into the shape of a sheet by the melt extrusion method can be produced.

A conductor-layer-included resin sheet according to the present disclosure includes the resin sheet according to the present disclosure and a conductor layer adjoining at least one principal surface of the resin sheet.

FIG. 4 is a schematic sectional view illustrating an example of the conductor-layer-included resin sheet according to the present disclosure.

A conductor-layer-included resin sheet 10 illustrated in FIG. 4 includes the resin sheet 1 and a conductor layer 2 in the stacking direction.

In the present specification, the stacking direction corresponds to a direction along the thickness direction of the resin sheet constituting the conductor-layer-included resin sheet.

The conductor layer 2 adjoins at least one of the principal surfaces of the resin sheet 1, that is, the first principal surface 1a herein.

The conductor layer 2 may be planar so as to spread over a surface or may be in the shape of a pattern so as to be patterned into a wiring line or the like.

Examples of the constituent material of the conductor layer 2 include copper, silver, aluminum, stainless steel, nickel, and gold and alloys containing at least one of these metals.

The conductor layer 2 is composed of, for example, metal foil and is preferably composed of copper foil of the metal foil. In such an instance, a metal other than copper may be present on the surface of the copper foil.

The thickness of the conductor layer 2 is preferably 1 μm to 35 μm and more preferably 6 μm to 18 μm.

The conductor-layer-included resin sheet 10 may further include, in addition to the conductor layer 2, another conductor layer adjoining the second principal surface 1b of the resin sheet 1.

The conductor-layer-included resin sheet 10 is produced by, for example, pressure-bonding the conductor layer 2 to the first principal surface 1a of the resin sheet 1. The conductor layer 2 may be etched so as to have a pattern shape after being pressure-bonded to the first principal surface 1a of the resin sheet 1.

The conductor-layer-included resin sheet 10 may be produced by pressure-bonding the conductor layer 2, which is patterned in advance, to the first principal surface 1a of the resin sheet 1.

A multilayer substrate according to the present disclosure includes the conductor-layer-included resin sheet according to the present disclosure.

FIG. 5 is a schematic sectional view illustrating an example of a multilayer substrate according to the present disclosure.

A multilayer substrate 50 illustrated in FIG. 5 includes a conductor-layer-included resin sheet 10A, a conductor-layer-included resin sheet 10B, and a conductor-layer-included resin sheet 10C successively in the stacking direction. That is, in the multilayer substrate 50, the conductor-layer-included resin sheet 10A, the conductor-layer-included resin sheet 10B, and the conductor-layer-included resin sheet 10C are stacked successively in the stacking direction.

The conductor-layer-included resin sheet 10A includes a resin sheet 1A and a conductor layer 2A.

The resin sheet 1A has a first principal surface 1Aa and a second principal surface 1Ab opposite each other in the thickness direction.

The resin sheet 1A is composed of a resin composition 1As including a liquid crystal polymer 1Ag and an inorganic filler 1Ah.

The conductor layer 2A adjoins the first principal surface 1Aa of the resin sheet 1A. In this regard, the conductor layer 2A also adjoins a second principal surface 1Bb of a resin sheet 1B described later.

The conductor-layer-included resin sheet 10B includes the resin sheet 1B, a conductor layer 2B, a conductor layer 2B′, and a conductor layer 2B″.

The resin sheet 1B has a first principal surface 1Ba and the second principal surface 1Bb opposite each other in the thickness direction.

The resin sheet 1B is composed of a resin composition 1Bs including a liquid crystal polymer 1Bg and an inorganic filler 1Bh.

The conductor layer 2B, the conductor layer 2B′, and the conductor layer 2B″ adjoin the first principal surface 1Ba of the resin sheet 1B. In addition, the conductor layer 2B, the conductor layer 2B′, and the conductor layer 2B″ also adjoin a second principal surface 1Cb of a resin sheet 1C described later.

The conductor-layer-included resin sheet 10C includes the resin sheet 1C and a conductor layer 2C.

The resin sheet 1C has a first principal surface 1Ca and the second principal surface 1Cb opposite each other in the thickness direction.

The resin sheet 1C is composed of a resin composition 1Cs including a liquid crystal polymer 1Cg and an inorganic filler 1Ch.

The conductor layer 2C adjoins the first principal surface 1Ca of the resin sheet 1C.

As illustrated in FIG. 5, it is preferable that the conductor layer 2B be disposed extending over the interface between the resin sheet 1B and the resin sheet 1C. Consequently, since the interface between the conductor layer 2B and the resin sheet 1B and the interface between the conductor layer 2B and the resin sheet 1C are sifted from the interface between the resin sheet 1B and the resin sheet 1C in the stacking direction, peeling at the interface between the conductor layer 2B and the resin sheet 1B and peeling at the interface between the conductor layer 2B and the resin sheet 1C are suppressed.

It is also preferable that the conductor layer 2B′ and the conductor layer 2B″ be disposed extending over the interface between the resin sheet 1B and the resin sheet 1C in the manner akin to that of the conductor layer 2B.

In this regard, in FIG. 5, the interface between the resin sheet 1B and the resin sheet 1C is illustrated. However, the interface is not limited to clearly appearing in practice. When the interface between the resin sheet 1B and the resin sheet 1C does not clearly appear, in a cross-section in the stacking direction as illustrated in FIG. 5, a plane that passes the center in the cross-section of the conductor layer 2B in the stacking direction and that extends in the in-plane direction orthogonal to the stacking direction is assumed to be the interface between the resin sheet 1B and the resin sheet 1C.

In at least one resin sheet (resin composition) of the resin sheet 1A (resin composition 1As), resin sheet 1B (resin composition 1Bs), and the resin sheet 1C (resin composition 1Cs), all the specific surface area of the inorganic filler being 30 m²/cm³ or less, the maximum diameter of the inorganic filler being 100 μm or less, and the content of the inorganic filler being 0.1% by volume to 60% by volume are satisfied.

That is, the multilayer substrate 50 may include a resin sheet that satisfies neither the specific surface area of the inorganic filler being 30 m²/cm³ or less nor the maximum diameter of the inorganic filler being 100 μm or less nor the content of the inorganic filler being 0.1% by volume to 60% by volume provided that at least one resin sheet that satisfies all the specific surface area of the inorganic filler being 30 m²/cm³ or less, the maximum diameter of the inorganic filler being 100 μm or less, and the content of the inorganic filler being 0.1% by volume to 60% by volume is included.

It is preferable that all the resin sheet 1A, the resin sheet 1B, and the resin sheet 1C satisfy all the specific surface area of the inorganic filler being 30 m²/cm³ or less, the maximum diameter of the inorganic filler being 100 μm or less, and the content of the inorganic filler being 0.1% by volume to 60% by volume.

The thicknesses of the resin sheet 1A, the resin sheet 1B, and the resin sheet 1C may be equal to each other, may differ from each other, or may partly differ as illustrated in FIG. 5.

Examples of the constituent material of the conductor layer 2A, the conductor layer 2B, the conductor layer 2B′, the conductor layer 2B″, and the conductor layer 2C include copper, silver, aluminum, stainless steel, nickel, and gold and alloys containing at least one of these metals in the manner akin to that of the constituent material of the conductor layer 2.

The conductor layer 2A, the conductor layer 2B, the conductor layer 2B′, the conductor layer 2B″, and the conductor layer 2C are composed of, for example, metal foil and are preferably composed of copper foil of the metal foil in the manner akin to that of conductor layer 2. In such an instance, a metal other than copper may be present on the surface of the copper foil.

The constituent materials of the conductor layer 2A, the conductor layer 2B, the conductor layer 2B′, the conductor layer 2B″, and the conductor layer 2C are preferably the same, but may differ from each other, or may partly differ.

The thicknesses of the conductor layer 2A, the conductor layer 2B, the conductor layer 2B′, the conductor layer 2B″, and the conductor layer 2C may be equal to each other as illustrated in FIG. 5, may differ from each other, or may partly differ.

The multilayer substrate 50 includes three conductor-layer-included resin sheets in the stacking direction, but may include only one, may include two, or may include four or more.

As illustrated in FIG. 5, it is preferable that the multilayer substrate 50 further include an interlayer connection conductor disposed so as to penetrate the resin sheet in the stacking direction and to be connected to the conductor layer without penetrating the conductor layer in the stacking direction.

The multilayer substrate 50 illustrated in FIG. 5 further includes an interlayer connection conductor 20A, an interlayer connection conductor 20B, an interlayer connection conductor 20C, and an interlayer connection conductor 20D.

The interlayer connection conductor 20A is disposed so as to penetrate the resin sheet 1B in the stacking direction and to be connected to the conductor layer 2B′ without penetrating the conductor layer 2B′ in the stacking direction. More specifically, the interlayer connection conductor 20A penetrates the resin sheet 1B in the stacking direction and is connected to the conductor layer 2B′ on the first principal surface 1Ba side of the resin sheet 1B. In addition, the interlayer connection conductor 20A is connected to the conductor layer 2A on the second principal surface 1Bb side of the resin sheet 1B. That is, the conductor layer 2A is electrically coupled to the conductor layer 2B′ with the interlayer connection conductor 20A interposed therebetween.

The interlayer connection conductor 20B is disposed at a position apart from the interlayer connection conductor 20A so as to penetrate the resin sheet 1B in the stacking direction and to be connected to the conductor layer 2B″ without penetrating the conductor layer 2B″ in the stacking direction. More specifically, the interlayer connection conductor 20B penetrates the resin sheet 1B in the stacking direction at a position apart from the interlayer connection conductor 20A and is connected to the conductor layer 2B″ on the first principal surface 1Ba side of the resin sheet 1B. In addition, the interlayer connection conductor 20B is connected, at a position apart from the interlayer connection conductor 20A, to the conductor layer 2A on the second principal surface 1Bb side of the resin sheet 1B. That is, the conductor layer 2A is electrically coupled to the conductor layer 2B″ with the interlayer connection conductor 20B interposed therebetween.

The interlayer connection conductor 20C is disposed so as to penetrate the resin sheet 1C in the stacking direction and to be connected to the conductor layer 2C without penetrating the conductor layer 2C in the stacking direction. More specifically, the interlayer connection conductor 20C penetrates the resin sheet 1C in the stacking direction and is connected to the conductor layer 2C on the first principal surface 1Ca side of the resin sheet 1C. In addition, the interlayer connection conductor 20C is connected to the conductor layer 2B′ on the second principal surface 1Cb side of the resin sheet 1C. That is, the conductor layer 2B′ is electrically coupled to the conductor layer 2C with the interlayer connection conductor 20C interposed therebetween.

The interlayer connection conductor 20D is disposed at a position apart from the interlayer connection conductor 20C so as to penetrate the resin sheet 1C in the stacking direction and to be connected to the conductor layer 2C without penetrating the conductor layer 2C in the stacking direction. More specifically, the interlayer connection conductor 20D penetrates the resin sheet 1C in the stacking direction at a position apart from the interlayer connection conductor 20C and is connected to the conductor layer 2C on the first principal surface 1Ca side of the resin sheet 1C. In addition, the interlayer connection conductor 20D is connected, at a position apart from the interlayer connection conductor 20C, to the conductor layer 2B″ on the second principal surface 1Cb side of the resin sheet 1C. That is, the conductor layer 2B″ is electrically coupled to the conductor layer 2C with the interlayer connection conductor 20D interposed therebetween.

As described above, in the multilayer substrate 50, the conductor layer 2A is electrically coupled to the conductor layer 2C with the interlayer connection conductor 20A, the conductor layer 2B′, and the interlayer connection conductor 20C interposed therebetween. In addition, in the multilayer substrate 50, the conductor layer 2A is also electrically coupled to the conductor layer 2C with the interlayer connection conductor 20B, the conductor layer 2B″, and the interlayer connection conductor 20D interposed therebetween.

The interlayer connection conductor 20A is formed by, for example, a via hole formed so as to pass through the resin sheet 1B in the thickness direction and to reach the conductor layer 2B′ without passing through the conductor layer 2B′ in the thickness direction being subjected to inner wall plating treatment or being filled with a conductive paste followed by heat treatment.

The interlayer connection conductor 20B, the interlayer connection conductor 20C, and the interlayer connection conductor 20D are formed in the same manner akin to that of the interlayer connection conductor 20A except that the positions of formation differ from each other.

When the interlayer connection conductor 20A, the interlayer connection conductor 20B, the interlayer connection conductor 20C, and the interlayer connection conductor 20D are formed by plating treatment, examples of the metal constituting each interlayer connection conductor include copper, tin, and silver. Of these, copper is preferable.

When the interlayer connection conductor 20A, the interlayer connection conductor 20B, the interlayer connection conductor 20C, and the interlayer connection conductor 20D are formed by heat treatment of a conductive paste, examples of the metal contained in each interlayer connection conductor include copper, tin, and silver. Each interlayer connection conductor preferably contains copper of these and more preferably contains copper and tin. For example, when the interlayer connection conductor 20A contains copper and tin, and the conductor layer 2B′ is composed of copper foil, the two tend to be electrically coupled to each other since the interlayer connection conductor 20A causes an alloying reaction with the conductor layer 2B′ at low temperature. The same applies to other combinations between the interlayer connection conductor and the conductor layer.

When the interlayer connection conductor 20A, the interlayer connection conductor 20B, the interlayer connection conductor 20C, and the interlayer connection conductor 20D are formed by heat treatment of a conductive paste, it is preferable that a resin contained in each interlayer connection conductor contain at least one thermosetting resin selected from the group consisting of epoxy resins, phenol resins, polyimide resins, silicon resins or modified resins thereof, and acrylic resins or at least one thermoplastic resin selected from the group consisting of polyamide resins, polystyrene resins, polymethacrylic resins, polycarbonate resins, and cellulose-based resins.

The multilayer substrate 50 is utilized as, for example, an electronic circuit board.

In the multilayer substrate 50, the conductor layer 2B may be a signal line to transmit a signal. That is, multilayer substrate 50 may include the conductor layer 2B as a signal line to transmit a signal. In such an instance, the multilayer substrate 50 constitutes a transmission line.

The multilayer substrate 50 includes the conductor layer 2B as a signal line to transmit a signal and may include the conductor layer 2A and the conductor layer 2C as a ground electrode. In such an instance, the multilayer substrate 50 constitutes a strip-line-type transmission line.

When the multilayer substrate 50 constitutes the above-described transmission line, the conductor layer 2B may be a signal line to transmit a high-frequency signal.

When the multilayer substrate 50 constitutes the transmission line, since the resin sheet 1B containing the liquid crystal polymer 1Bg having low permittivity and the resin sheet 1C containing the liquid crystal polymer 1Cg having low permittivity are in contact with the conductor layer 2B, that is, the signal line, the transmission characteristics of the multilayer substrate 50 are readily improved.

The multilayer substrate 50 is produced by, for example, the following method.

### <Step of Producing Conductor-Layer-Included Resin Sheet>

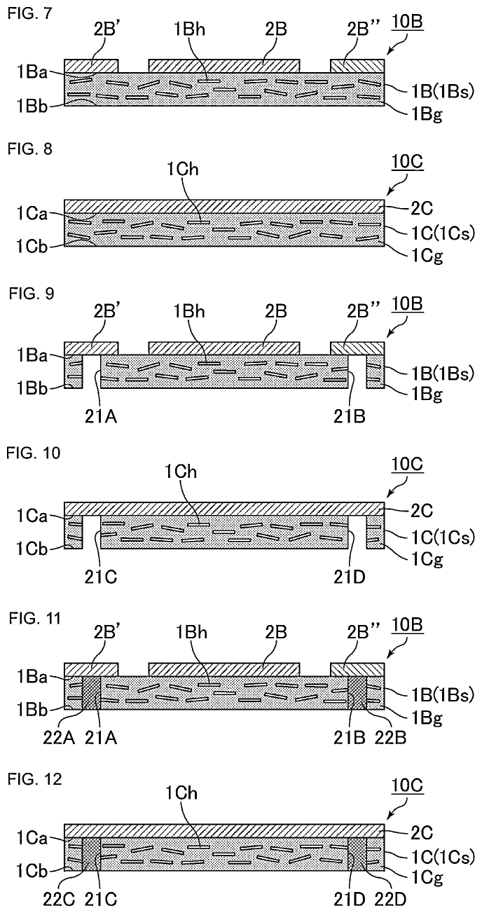

FIG. 6, FIG. 7, and FIG. 8 are schematic sectional views illustrating a step of producing a conductor-layer-included resin sheet in an example of a method for manufacturing the multilayer substrate according to the present disclosure.

As illustrated in FIG. 6, the conductor-layer-included resin sheet 10A in which the conductor layer 2A is disposed so as to adjoin the first principal surface 1Aa of the resin sheet 1A is produced. In such an instance, for example, the conductor layer 2A is pressure-bonded to the first principal surface 1Aa of the resin sheet 1A.

As illustrated in FIG. 7, the conductor-layer-included resin sheet 10B in which the conductor layer 2B, the conductor layer 2B′, and the conductor layer 2B″ are disposed so as to adjoin the first principal surface 1Ba of the resin sheet 1B is produced. In such an instance, for example, after a conductor layer is pressure-bonded to the first principal surface 1Ba of the resin sheet 1B, the conductor layer is etched so as to be patterned into the conductor layer 2B, the conductor layer 2B′, and the conductor layer 2B″. Alternatively, after the conductor layer 2B, the conductor layer 2B′, and the conductor layer 2B″ are prepared in advance, each conductor layer is pressure-bonded to the first principal surface 1Ba of the resin sheet 1B.

As illustrated in FIG. 8, the conductor-layer-included resin sheet 10C in which the conductor layer 2C is disposed so as to adjoin the first principal surface 1Ca of the resin sheet 1C is produced. In such an instance, for example, the conductor layer 2C is pressure-bonded to the first principal surface 1Ca of the resin sheet 1C.

### <Step of Forming Via Hole>

FIG. 9 and FIG. 10 are schematic sectional views illustrating a step of forming a via hole in an example of a method for manufacturing the multilayer substrate according to the present disclosure.

As illustrated in FIG. 9, a via hole 21A is formed in the conductor-layer-included resin sheet 10B so as to pass through the resin sheet 1B in the thickness direction and to reach the conductor layer 2B′ without passing through the conductor layer 2B′ in the thickness direction. Consequently, a portion of the conductor layer 2B′ is exposed at the via hole 21A.

In addition, a via hole 21B is formed at a position apart from the position at which the via hole 21A is formed in the conductor-layer-included resin sheet 10B so as to pass through the resin sheet 1B in the thickness direction and to reach the conductor layer 2B″ without passing through the conductor layer 2B″ in the thickness direction. Consequently, a portion of the conductor layer 2B″ is exposed at the via hole 21B.

Accordingly, the via hole 21A and the via hole 21B are formed in the conductor-layer-included resin sheet 10B. In such an instance, the via hole 21A and the via hole 21B may be formed at the same timing or may be formed at different timings.

As illustrated in FIG. 10, a via hole 21C is formed in the conductor-layer-included resin sheet 10C so as to pass through the resin sheet 1C in the thickness direction and to reach the conductor layer 2C without passing through the conductor layer 2C in the thickness direction. Consequently, a portion of the conductor layer 2C is exposed at the via hole 21C.

In addition, a via hole 21D is formed at a position apart from the position at which the via hole 21C is formed in the conductor-layer-included resin sheet 10C so as to pass through the resin sheet 1C in the thickness direction and to reach the conductor layer 2C without passing through the conductor layer 2C in the thickness direction. Consequently, a portion of the conductor layer 2C is exposed at the via hole 21D.

Accordingly, the via hole 21C and the via hole 21D are formed in the conductor-layer-included resin sheet 10C. In such an instance, the via hole 21C and the via hole 21D may be formed at the same timing or may be formed at different timings.

When the via hole 21A, the via hole 21B, the via hole 21C, and the via hole 21D are formed, it is preferable that laser light be applied to the conductor-layer-included resin sheet from the resin sheet side.

### <Step of Introducing Conductive Paste>

FIG. 11 and FIG. 12 are schematic sectional views illustrating a step of introducing a conductive paste in an example of a method for manufacturing the multilayer substrate according to the present disclosure.

As illustrated in FIG. 11, a conductive paste 22A is introduced in the via hole 21A in the conductor-layer-included resin sheet 10B. In addition, a conductive paste 22B is introduced in the via hole 21B in the conductor-layer-included resin sheet 10B. In such an instance, the conductive paste 22A and the conductive paste 22B may be introduced at the same timing or introduced at different timings.

As illustrated in FIG. 12, a conductive paste 22C is introduced in the via hole 21C in the conductor-layer-included resin sheet 10C. In addition, a conductive paste 22D is introduced in the via hole 21D in the conductor-layer-included resin sheet 10C. In such an instance, the conductive paste 22C and the conductive paste 22D may be introduced at the same timing or introduced at different timings.

Examples of the method for introducing the conductive paste 22A, the conductive paste 22B, the conductive paste 22C, and the conductive paste 22D include a screen printing method and a vacuum filling method.

Each of the conductive paste 22A, the conductive paste 22B, the conductive paste 22C, and the conductive paste 22D contains, for example, a metal and a resin.

Examples of the metal contained in each conductive paste of the conductive paste 22A, the conductive paste 22B, the conductive paste 22C, and the conductive paste 22D include copper, tin, and silver. Of these, each conductive paste preferably contains copper and more preferably contains copper and tin.

Examples of the resin contained in each conductive paste of the conductive paste 22A, the conductive paste 22B, the conductive paste 22C, and the conductive paste 22D preferably include at least one thermosetting resin selected from the group consisting of epoxy resins, phenol resins, polyimide resins, silicon resins or modified resins thereof, and acrylic resins or at least one thermoplastic resin selected from the group consisting of polyamide resins, polystyrene resins, polymethacrylic resins, polycarbonate resins, and cellulose-based resins.

Each conductive paste of the conductive paste 22A, the conductive paste 22B, the conductive paste 22C, and the conductive paste 22D may further contain a vehicle, a solvent, a thixotropic agent, an activator, and the like.

Examples of the vehicle include rosin-based resins composed of rosin or derivatives such as modified rosin produced by modifying rosin, synthetic resins composed of rosin or derivatives such as modified rosin produced by modifying rosin, and mixtures of these resins.

Examples of the rosin-based resin composed of rosin or derivatives such as modified rosin produced by modifying rosin include gum rosin, tall rosin, wood rosin, polymerized rosin, hydrogenated rosin, formylated rosin, rosin esters, rosin-modified maleic acid resins, rosin-modified phenol resins, rosin-modified alkyd resins, and other various rosin derivatives.

Examples of the synthetic resin composed of rosin or derivatives such as modified rosin produced by modifying rosin include polyester resins, polyamide resins, phenoxy resins, and terpene resins.

Examples of the solvent include alcohols, ketones, esters, ethers, aromatic series, and hydrocarbons. Specific examples of these include benzyl alcohol, ethanol, isopropyl alcohol, butanol, diethylene glycol, ethylene glycol, glycerin, ethylcellosolve, butylcellosolve, ethyl acetate, butyl acetate, butyl benzoate, diethyl adipate, dodecane, tetradecene, α-terpineol, terpineol, 2-methyl-2,4-pentanediol, 2-ethylhexanediol, toluene, xylene, propylene glycol monophenyl ether, diethylene glycol monohexyl ether, ethylene glycol monobutyl ether, diethylene glycol monobutyl ether, diethylene glycol monoethyl ether, diisobutyl adipate, hexylene glycol, cyclohexane dimethanol, 2-terpinyloxyethanol, and 2-dihydroterpinyloxyethanol and mixtures thereof. Of these, terpineol, ethylene glycol monobutyl ether, diethylene glycol monobutyl ether, and diethylene glycol monoethyl ether are preferable.

Examples of the thixotropic agent include hardened castor oil, carnauba wax, amides, hydroxyfatty acids, dibenzylidene sorbitol, bis(p-methybenzylidene)sorbitols, beeswax, amide stearate, and ethylenebisamide hydroxystearate. In this regard, as the situation demands, fatty acids, such as caprylic acid, lauric acid, myristic acid, palmitic acid, stearic acid, and behenic acid, hydroxyfatty acids, such as 1,2-hydroxystearic acid, antioxidants, surfactants, and amines may be added to these thixotropic agents.

Examples of the activator include hydrohalic acid salts of amines, organic halogen compounds, organic acids, organic amines, and polyhydric alcohols.

Examples of the hydrohalic acid salt of an amine include diphenylguanidine hydrobromides, diphenylguanidine hydrochlorides, cyclohexylamine hydrobromides, ethylamine hydrochlorides, ethylamine hydrobromides, diethylaniline hydrobromides, diethylaniline hydrochlorides, triethanolamine hydrobromides, and monoethanolamine hydrobromides.

Examples of the organic halogen compound include paraffin chlorides, tetrabromoethane, dibromopropanol, 2,3-dibromo-1,4-butanediol, 2,3-dibromo-2-butene-1,4-diol, and tris(2,3-dibromopropyl)isocyanurate.

Examples of the organic acid include malonic acid, fumaric acid, glycol acid, citric acid, malic acid, succinic acid, phenylsuccinic acid, maleic acid, salicylic acid, anthranilic acid, glutaric acid, suberic acid, adipic acid, sebacic acid, stearic acid, abietic acid, benzoic acid, trimellitic acid, pyromellitic acid, and dodecanoic acid.

Examples of the organic amine include monoethanolamine, diethanolamine, triethanolamine, tributylamine, aniline, and diethylaniline.

Examples of the polyhydric alcohol include erythritol, pyrogallol, and ribitol.

### <Step of Forming Interlayer Connection Conductor>

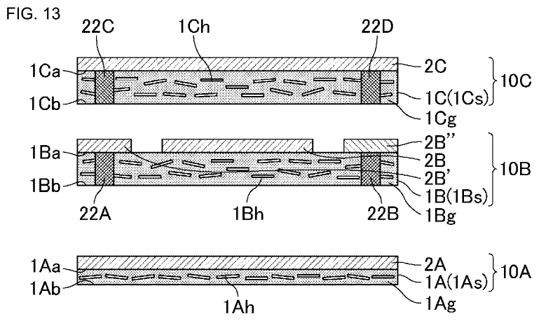

FIG. 13 is a schematic sectional view illustrating a step of forming the interlayer connection conductor in an example of a method for manufacturing the multilayer substrate according to the present disclosure.

As illustrated in FIG. 13, the conductor-layer-included resin sheet 10A, the conductor-layer-included resin sheet 10B filled with the conductive paste 22A and the conductive paste 22B, and the conductor-layer-included resin sheet 10C filled with the conductive paste 22C and the conductive paste 22D are successively stacked in the stacking direction. In such an instance, stacking is performed so that the surface (upper surface) on the conductor layer 2A side of the conductor-layer-included resin sheet 10A is in contact with the surface (lower surface) on the resin sheet 1B side of the conductor-layer-included resin sheet 10B and that the surface (upper surface) on the conductor layer 2B side (conductor layer 2B′ side, conductor layer 2B″ side) of the conductor-layer-included resin sheet 10B is in contact with the surface (lower surface) on the resin sheet 1C side of the conductor-layer-included resin sheet 10C. In this regard, for the sake of facilitating explanation, in FIG. 13, the conductor-layer-included resin sheets are illustrated apart from each other.

Subsequently, the resulting multilayer body is subjected to heat pressing by applying a pressure in the stacking direction while performing heating. Consequently, the conductor-layer-included resin sheet 10A is pressure-bonded to the conductor-layer-included resin sheet 10B, and the conductor-layer-included resin sheet 10B is pressure-bonded to the conductor-layer-included resin sheet 10C. In addition, the conductive paste 22A, the conductive paste 22B, the conductive paste 22C, and the conductive paste 22D are solidified during heat pressing so as to become the interlayer connection conductor 20A, the interlayer connection conductor 20B, the interlayer connection conductor 20C, and the interlayer connection conductor 20D, respectively. Accordingly, the interlayer connection conductor 20A, the interlayer connection conductor 20B, the interlayer connection conductor 20C, and the interlayer connection conductor 20D are formed in the via hole 21A, the via hole 21B, the via hole 21C, the via hole 21D, respectively.

When the interlayer connection conductor 20A, the interlayer connection conductor 20B, the interlayer connection conductor 20C, and the interlayer connection conductor 20D are formed, the inner wall of the via hole may be subjected to plating treatment by using a metal, such as copper, tin, or silver, rather than the via hole being filled with the conductive paste.

In the above description, the aspect in which, when the interlayer connection conductor is formed, the via hole formed so as to pass through the resin sheet in the thickness direction and to reach the conductor layer without passing through the conductor layer in the thickness direction is filled with the conductive paste or subjected to plating treatment is exemplified. But, the interlayer connection conductor may be formed by a via hole formed so as to pass through both the resin sheet and the conductor layer in the thickness direction being filled with the conductive paste or subjected to plating treatment.

As described above, the multilayer substrate 50 illustrated in FIG. 5 is produced.

### EXAMPLES

Examples more specifically disclosing the resin composition according to the present disclosure and the resin sheet according to the present disclosure will be described below. In this regard, the present disclosure is not limited to Examples below.

### Examples 1 to 8

Resin compositions and Resin sheets of Examples 1 to 8 were produced by a method described below.

Initially, a resin composition in a molten state was produced by melt-kneading a liquid crystal polymer presented in Table 1 and an inorganic filler presented in Table 1 by using a twin screw extruder. The contents of the liquid crystal polymer and the inorganic filler in the resin composition are as presented in Table 1.

Subsequently, the resin composition was molded into the shape of a sheet by ejecting the resin composition in a molten state from a T die and, thereafter, performing cooling.

### Comparative Examples 1 to 6

Resin compositions and resin sheets of Comparative examples 1 to 6 were produced in the same manner akin to that of Examples 1 to 8 except that liquid crystal polymers presented in Table 2 and inorganic fillers presented in Table 2 were used.

### Comparative Example 7

A resin composition of Comparative example 7 was produced by using a liquid crystal polymer presented in Table 2 and an inorganic filler presented in Table 2. Thereafter, a resin sheet of Comparative example 7 was produced in accordance with Production example 1 described in Patent Document 3.

In this regard, a liquid crystal polymer A and a liquid crystal polymer B presented in Table 1 and Table 2 were as described below.
Liquid crystal polymer A: copolymer of 73% by mole of p-hydroxybenzoic acid and 27% by mole of 6-hydroxy-2-naphthoic acid
Liquid crystal polymer B: copolymer of 80% by mole of p-hydroxybenzoic acid and 20% by mole of 6-hydroxy-2-naphthoic acid

In addition, characteristics of the inorganic fillers presented in Table 1 and Table 2 were determined as described below.

### <Specific Surface Area>

Initially, the inorganic filler was deaerated at 150° C. for 20 min. Thereafter, Full Automatic Specific Surface Area Analyzer “Macsorb (registered trademark)” produced by Mountech Co., Ltd. was used, and the specific surface area of the inorganic filler was measured by the BET single point method. Specifically, the specific surface area of the inorganic filler was calculated from the amount of nitrogen gas adsorbed onto the surface of about 0.1 g to 1.0 g of weighed inorganic filler.

### <Maximum Diameter>

Initially, the inorganic filler was subjected to ultrasonic dispersion in ethanol. Thereafter, Laser Diffraction/Scattering Particle Size Distribution Analyzer “LA-960” produced by HORIBA, Ltd. was used, and the particle size distribution of the inorganic filler was measured by a laser diffraction/scattering method. In such an instance, the particle diameter of the inorganic filler was measured as an equivalent circle diameter. Then, the maximum particle diameter in the obtained particle size distribution of the inorganic filler was determined as the maximum diameter of the inorganic filler.

### <Average Particle Diameter>

Initially, the cumulative particle size distribution of the inorganic filler on a volume basis was determined by converting the particle size distribution of the inorganic filler obtained in determination of the maximum diameter of the inorganic filler to the particle size distribution expressed in the cumulative probability. Subsequently, a median diameter D₅₀ was determined from the obtained cumulative particle size distribution of the inorganic filler on a volume basis, and the median diameter D₅₀ was determined as the average particle diameter of the inorganic filler.

### <Thickness>

Initially, an image of the inorganic filler was picked up by using a scanning electron microscope. Subsequently, the resulting image of the inorganic filler was subjected to image analysis by using analysis software so that the dimension of the inorganic filler in the short side direction was measured. Herein, 100 inorganic fillers were subjected to the dimension measurement in the short side direction, and an average value of the obtained 100 measurement values was determined as the thickness of the inorganic filler.

### <Aspect Ratio>

Initially, an image of the inorganic filler was picked up by using a scanning electron microscope. Subsequently, the resulting image of the inorganic filler was subjected to image analysis by using analysis software so that the dimension of the inorganic filler in the short side direction and the dimension of the inorganic filler in the long side direction were measured. Herein, 100 inorganic fillers were subjected to the above-described dimension measurement in the short side direction and the long side direction, and B/A was determined as the aspect ratio of the inorganic filler where an average value of the 100 measurement values obtained as the dimension in the short side direction was denoted by A, and an average value of the 100 measurement values obtained as the dimension in the long side direction was denoted by B.

In this regard, when the inorganic filler was spherical, the thickness and the aspect ratio of the inorganic filler were not determined.

### <Evaluation>

Regarding Examples 1 to 8 and Comparative examples 1 to 7, the following evaluation was performed. The results are presented in Table 1 and Table 2.

### <Melting Point>

Differential Scanning Calorimeter “DSC7000X” produced by Hitachi High-Tech Science Corporation was used, and the resin sheet was completely melted by increasing the temperature at a temperature increase rate of 20° C./min. Subsequently, the temperature of the obtained melt was decreased to 175° C. at a temperature decrease rate of 20° C./min and, thereafter, increased again at a temperature increase rate of 20° C./min. Herein, the temperature corresponding to an endothermic peak observed during the temperature increase was determined as the melting point of the resin composition contained in the resin sheet. In this regard, when an endothermic peak was not readily observed by the above-described method, the melting point of the resin composition contained in the resin sheet was determined by texture observation with a polarizing microscope under the crossed-Nicol condition.

### <Melt Tension>

The melt tension of the resin composition contained in the resin sheet was measured by using Capilograph (registered trademark) “F-1” produced by Toyo Seiki Seisaku-sho, Ltd. at a temperature 20° C. higher than the melting point of the resin composition specified in the above-described method. In such an instance, the barrel diameter of a cylinder was set to be 9.55 mm, the capillary diameter was set to be 1 mm, and the strand drawing speed was set to be 150 m/min.

### <Possibility of Sheet Formation>

Whether the resin composition can be molded into the shape of a sheet was evaluated in accordance with the following rating criteria. In this regard, when the resin composition was able to be molded into the shape of a sheet, the thickness of the obtained resin sheet was 100 μm.
yes: the resin composition was not broken during cooling in <Step of molding resin composition into shape of sheet>, and the resin composition was able to be molded into the shape of a sheet
no: the resin composition was broken during cooling in <Step of molding resin composition into shape of sheet>, and the resin composition was unable to be molded into the shape of a sheet

### <Contamination>

Initially, a simultaneous thermogravimetry-differential thermal analysis device was used, and a resin component (liquid crystal polymer or the like) in the resin sheet was completely removed by increasing the temperature of the resin sheet from room temperature to 600° C. at a temperature increase rate of 10° C./min in an air atmosphere and, thereafter, leaving to stand for 45 min at 600° C. Subsequently, an inorganic component remaining after removal of the resin component was subjected to element analysis based on the transmission electron microscope-energy dispersive X-ray analysis (SEM-EDX) so that whether contamination of the resin sheet occurred was evaluated in accordance with the following rating criteria.
yes: as a result of element analysis of the inorganic component, an iron component was detected
no: as a result of element analysis of the inorganic component, no iron component was detected

### <Water Absorption>

Initially, five samples of 50 mm×50 mm were cut from the resin sheet. Subsequently, the five samples were placed in an oven set at 130° C., left to stand for 30 min, and placed in a desiccator so as to be cooled to room temperature. Thereafter, a total weight M1 of the five samples were measured. Subsequently, the five samples were completely immersed in distilled water at room temperature, and left to stand for 24 hours. The five samples were removed from the distilled water, and water droplets on the surface of each sample was wiped. Thereafter, a total weight M2 of the five samples was measured. Then, a value of “100×(M2−M1)/M1” (unit: %) was determined by calculation, and the calculated value was determined as the water absorption of the resin sheet. The rating criteria of the water absorption were set to be as described below.
⊚ (excellent): the water absorption was 0.05% or less
∘ (good): the water absorption was more than 0.05% and 0.10% or less

### <Tensile Elongation at Break>

A tensile test of the resin sheet was performed in conformity with “ASTM D882”, and a value of “100×(L2−L1)/L1” (unit: %) was determined by calculation, where the dimension of the resin sheet before the tensile test in the tensile direction was denoted by L1, and the dimension at the time when the resin sheet was broken during the tensile test was denoted by L2. In the present evaluation, regarding the resin sheet, the above-described calculation values were determined by performing the tensile test of five samples with respect to each of tensile directions, where the tensile directions were set to be a resin sheet flow direction (MD) corresponding to the direction in which the resin composition was ejected from the T die when the resin sheet was produced and a vertical direction (TD) orthogonal to the resin sheet flow direction. Then an average value of these calculation values was determined as the tensile elongation at break of the resin sheet. In this regard, the resin sheet flow direction and the vertical direction were directions included in the in-plane direction orthogonal to the thickness direction. The rating criteria of the tensile elongation at break were set to be as described below.
⊚ (excellent): the tensile elongation at break was 10% or more
∘ (good): the tensile elongation at break was 5% to less than 10%
x (poor): the tensile elongation at break was less than 5%

### <Coefficient of Linear Expansion in In-Plane Direction>

Initially, a sample of 20 mm×4 mm was cut from the resin sheet and set in a glove of a thermomechanical analyzer produced by Seiko Instruments Inc. in a state of a chuck distance of 10 mm. Subsequently, the temperature was increased to 170° C. at a temperature increase rate of 40° C./min, and thereafter the temperature was decreased to 30° C. at a temperature decrease rate of 10° C./min while a load of 5 g was applied to the sample. Then, the coefficient of linear expansion of the resin sheet was determined by measuring an amount of change in the chuck distance in a temperature range of 100° C. to 50° C. during the temperature decrease. In the present evaluation, the coefficients of linear expansion of the resin sheet in the flow direction (MD) and the vertical direction (TD) were determined by the above-described method, and an average value of these was determined as the coefficient of linear expansion of the resin sheet in the in-plane direction. The rating criteria of the coefficient of linear expansion of the resin sheet in the in-plane direction were set as described below.
⊚ (excellent): the coefficient of linear expansion in the in-plane direction was within the range of 16±4 ppm/K
∘ (good): the coefficient of linear expansion in the in-plane direction was outside the range of 16±4 ppm/K but within the range of 16±8 ppm/K
x (poor): the coefficient of linear expansion in the in-plane direction was outside the range of 16±8 ppm/K

TABLE 1

| | | | Example | Example | Example | Example | Example | Example | Example | Example |
|---|---|---|---|---|---|---|---|---|---|---|
| | | | 1 | 2 | 3 | 4 | 5 | 6 | 7 | 8 |
| Liquid | Composition | — | A | A | A | B | B | B | A | A |
| crystal | Content | vol % | 90 | 90 | 90 | 90 | 90 | 90 | 45 | 70 |
| polymer | | | | | | | | | | |
| Inorganic | Composition | — | alumina | alumina | alumina | alumina | alumina | alumina | boron | talc |
| filler | | | | | | | | | nitride | |
| | Shape | — | tabular | tabular | spherical | tabular | tabular | spherical | tabular | tabular |
| | Specific | m²/cm³ | 28.2 | 14.5 | 5.1 | 28.2 | 14.5 | 5.1 | 9 | 18 |
| | surface area | | | | | | | | | |
| | Maximum | μm | 16 | 93 | 8 | 16 | 93 | 8 | 88 | 11 |
| | diameter | | | | | | | | | |
| | Average | μm | 2.8 | 32 | 2.1 | 2.8 | 32 | 2.1 | 27 | 2.5 |
| | particle | | | | | | | | | |
| | diameter | | | | | | | | | |
| | Thickness | nm | 200 | 600 | — | 200 | 600 | — | 450 | 150 |
| | Aspect ratio | — | 25 | 75 | — | 25 | 75 | — | 70 | 30 |
| | Content | vol % | 10 | 10 | 10 | 10 | 10 | 10 | 55 | 30 |
| Production method | | — | melt | melt | melt | melt | melt | melt | melt | melt |
| | | | extrusion | extrusion | extrusion | extrusion | extrusion | extrusion | extrusion | extrusion |
| | | | method | method | method | method | method | method | method | method |
| Evaluation | Melting point | ° C. | 280 | 280 | 280 | 320 | 320 | 320 | 280 | 280 |
| result | Melt tension | mN | 1.2 | 3.9 | 6.1 | 1.1 | 3.7 | 5.9 | 4.6 | 2.2 |
| | Possibility of | — | yes | yes | yes | yes | yes | yes | yes | yes |
| | sheet | | | | | | | | | |
| | formation | | | | | | | | | |
| | Contamination | — | no | no | no | no | no | no | no | no |
| | Water | % | 0.08 | 0.04 | 0.03 | 0.08 | 0.04 | 0.03 | 0.03 | 0.04 |
| | absorption | Rating | ◯ | ⊚ | ⊚ | ◯ | ⊚ | ⊚ | ⊚ | ⊚ |
| | Tensile | % | 22 | 20 | 9 | 18 | 15 | 7 | 11 | 13 |
| | elongation at | Rating | ⊚ | ⊚ | ◯ | ⊚ | ⊚ | ◯ | ⊚ | ⊚ |
| | break | | | | | | | | | |
| | Coefficient of | ppm/K | 16 | 21 | 23 | 15 | 21 | 24 | 12 | 14 |
| | linear | Rating | ⊚ | ◯ | ◯ | ⊚ | ◯ | ◯ | ⊚ | ⊚ |
| | expansion in | | | | | | | | | |
| | in-plane | | | | | | | | | |
| | direction | | | | | | | | | |

TABLE 2

| | | | Comp. | Comp. | Comp. | Comp. | Comp. | Comp. | Comp. |
|---|---|---|---|---|---|---|---|---|---|
| | | | example 1 | example 2 | example 3 | example 4 | example 5 | example 6 | example 7 |
| Liquid | Composition | — | A | A | A | B | B | B | A |
| crystal | Content | vol % | 90 | 90 | 35 | 90 | 90 | 35 | 70 |
| polymer | | | | | | | | | |
| Inorganic | Composition | — | alumina | alumina | alumina | alumina | alumina | alumina | talc |
| filler | Shape | — | tabular | tabular | tabular | tabular | tabular | tabular | tabular |
| | Specific | m²/cm³ | 33 | 12.9 | 28.2 | 33 | 12.9 | 28.2 | 18 |
| | surface area | | | | | | | | |
| | Maximum | μm | 12 | 103 | 16 | 12 | 103 | 16 | 11 |
| | diameter | | | | | | | | |
| | Average | μm | 2.1 | 35 | 2.8 | 2.1 | 35 | 2.8 | 2.5 |
| | particle | | | | | | | | |
| | diameter | | | | | | | | |
| | Thickness | nm | 150 | 800 | 200 | 150 | 800 | 200 | 150 |
| | Aspect ratio | — | 25 | 50 | 25 | 25 | 50 | 25 | 30 |
| | Content | vol % | 10 | 10 | 65 | 10 | 10 | 65 | 30 |
| Production method | | — | melt | melt | melt | melt | melt | melt | Patent |
| | | | extrusion | extrusion | extrusion | extrusion | extrusion | extrusion | Document 3 |
| | | | method | method | method | method | method | method | Production |
| | | | | | | | | | example 1 |
| Evaluation | Melting point | ° C. | 280 | 280 | 280 | 320 | 320 | 320 | 280 |
| result | Melt tension | mN | 0.9 | 4.5 | 0.5 | 0.7 | 4.1 | 0.4 | 2.2 |
| | Possibility of | — | no | no | no | no | no | no | yes |
| | sheet | | | | | | | | |
| | formation | | | | | | | | |
| | Contamination | — | — | — | — | — | — | — | yes |
| | Water | % | — | — | — | — | — | — | — |
| | absorption | Rating | — | — | — | — | — | — | — |
| | Tensile | % | — | — | — | — | — | — | — |
| | elongation at | Rating | — | — | — | — | — | — | — |
| | break | | | | | | | | |
| | Coefficient of | ppm/K | — | — | — | — | — | — | — |
| | linear | | | | | | | | |
| | expansion in | | | | | | | | |
| | in-plane | Rating | — | — | — | — | — | — | — |
| | direction | | | | | | | | |

As presented in Table 1, regarding Examples 1 to 8 in which all the specific surface area of the inorganic tiller being 30 m²/cm³ or less, the maximum diameter of the inorganic filler being 100 μm or less, and the content of the inorganic filler being 0.1% by volume to 60% by volume were satisfied, the resin composition was able to be molded into the shape of a sheet by the melt extrusion method without causing contamination.

Regarding the resin compositions of Examples 1 to 8, the melt tension at a temperature 20° C. higher than the melting point of the resin composition was 1.0 mN or more.

Regarding Examples 1 to 8, the water absorption of the resin sheet of Example 2, Example 3, Example 5, Example 6, Example 7, or Example 8 in which the specific surface area of the inorganic filler was 20 m²/cm³ or less was low compared with the water absorption of the resin sheet of Example 1 or Example 4 in which the specific surface area of the inorganic filler was more than 20 m²/cm³.

Regarding Examples 1 to 8, the resin sheet of Example 3 or Example 6 in which the tensile elongation at break was 5% to less than 10% was not cracked even when being bent at 90°. Further, regarding Examples 1 to 8, the resin sheet of Example 1, Example 2, Example 4, Example 5, Example 7, or Example 8 in which the tensile elongation at break was 10% or more was not cracked even when being bent at 180°.

Regarding Examples 1 to 8, since the coefficient of linear expansion in the in-plane direction of the resin sheet of Example 2, Example 3, Example 5, or Example 6 in which the coefficient of linear expansion in the in-plane direction was outside the range of 16±4 ppm/K but within the range of 16±8 ppm/K was close to that of copper foil (about 16 ppm/K), when a conductor-layer-included resin sheet or a multilayer substrate was formed by using the resin sheet and the copper foil, warping did not readily occur. Further, regarding Examples 1 to 8, since the coefficient of linear expansion in the in-plane direction of the resin sheet of Example 1, Example 4, Example 7, or Example 8 in which the coefficient of linear expansion in the in-plane direction was within the range of 16±4 ppm/K was sufficiently close to that of the copper foil (about 16 ppm/K), when a conductor-layer-included resin sheet or a multilayer substrate was formed by using the resin sheet and the copper foil, warping did not occur.

On the other hand, as presented in Table 2, regarding Comparative example 1 or Comparative example 4 in which the specific surface area of the inorganic filler was not 30 m²/cm³ or less, the resin composition was unable to be molded into the shape of a sheet by the melt extrusion method.

As presented in Table 2, regarding Comparative example 2 or Comparative example 5 in which the maximum diameter of the inorganic filler was not 100 μm or less, the resin composition was unable to be molded into the shape of a sheet by the melt extrusion method.

As presented in Table 2, regarding Comparative example 3 or Comparative example 6 in which the content of the inorganic filler was not 0.1% by volume to 60% by volume, the resin composition was unable to be molded into the shape of a sheet by the melt extrusion method.

As presented in Table 2, regarding Comparative example 7, the resin composition was able to be molded into the shape of a sheet, but contamination occurred in the obtained resin sheet.

As described above, regarding Comparative examples 1 to 6, since the resin sheet was unable to be produced, the water absorption, the tensile elongation at break, and the coefficient of linear expansion in the in-plane direction were unable to be evaluated. In addition, regarding Comparative example 7, the water absorption, the tensile elongation at break, and the coefficient of linear expansion in the in-plane direction were not evaluated since there was an influence of contamination.

In the present specification, the following contents are disclosed.

<1> A resin composition including: a resin component comprising a liquid crystal polymer as a primary component thereof; and an inorganic filler, wherein a specific surface area of the inorganic filler is 30 m²/cm³ or less, a maximum diameter of the inorganic filler is 100 μm or less, and a content of the inorganic filler is 0.1% by volume to 60% by volume.

<2> The resin composition according to <1>, wherein the specific surface area of the inorganic filler is 20 m²/cm³ or less.

<3> The resin composition according to <1> or <2>, wherein the inorganic filler is tabular.

<4> The resin composition according to <3>, wherein an average particle diameter of the inorganic filler is 0.1 μm to 30 μm, a thickness of the inorganic filler is 1 nm to 1000 nm, and an aspect ratio of the inorganic filler is 2 to 100.

<5> The resin composition according to any one of <1> to <4>, wherein a melt tension at a temperature 20° C. higher than a melting point of the resin composition is 1.0 mN or more.

<6> A resin sheet composed of the resin composition according to any one of <1> to <5>.

<7> A conductor-layer-included resin sheet including: the resin sheet according to <6>, and a conductor layer adjoining at least one principal surface of the resin sheet.

<8> A multilayer substrate including the conductor-layer-included resin sheet according to <7>.

<9> A method for manufacturing a resin sheet, including: preparing a resin composition that includes (1) a resin component comprising a liquid crystal polymer a primary component thereof and (2) an inorganic filler having a specific surface area of 30 m²/cm³ or less and a maximum diameter of 100 μm or less, wherein a content of the inorganic filler is 0.1% by volume to 60% by volume; and molding the resin composition into a sheet by melt extrusion.

### REFERENCE SIGNS LIST

1, 1′, 1″, 1A, 1B, 1C resin sheet
1a, 1Aa, 1Ba, 1Ca first principal surface of resin sheet
1b, 1Ab, 1Bb, 1Cb second principal surface of resin sheet
1g, 1Ag, 1Bg, 1Cg liquid crystal polymer
1h, 1h″, 1Ah, 1Bh, 1Ch inorganic filler
1s, 1s′, 1s″, 1As, 1Bs, 1Cs resin composition
2, 2A, 2B, 2B′, 2B″, 2C conductor layer
3 surface treatment layer
10, 10A, 10B, 10C conductor-layer-included resin sheet
20A, 20B, 20C, 20D interlayer connection conductor
21A, 21B, 21C, 21D via hole
22A, 22B, 22C, 22D conductive paste
50 multilayer substrate

1. A resin composition comprising:
a resin component comprising a liquid crystal polymer as a primary component thereof; and
an inorganic filler,
wherein a specific surface area of the inorganic filler is 30 m²/cm³ or less,
a maximum diameter of the inorganic filler is 100 μm or less, and
a content of the inorganic filler is 0.1% by volume to 60% by volume.

2. The resin composition according to claim 1, wherein the liquid crystal polymer contains a copolymer of p-hydroxybenzoic acid and 6-hydroxy-2-naphthoic acid.

3. The resin composition according to claim 2, wherein a molar ratio of the p-hydroxybenzoic acid to the 6-hydroxy-2-naphthoic acid is 0.20 to 5.

4. The resin composition according to claim 2, wherein the liquid crystal polymer contains 10% by mole or more of each of the p-hydroxybenzoic acid and the 6-hydroxy-2-naphthoic acid when a total amount of monomers in the liquid crystal polymer is 100% by mole.

5. The resin composition according to claim 1, wherein the specific surface area of the inorganic filler is 20 m²/cm³ or less.

6. The resin composition according to claim 1, wherein the inorganic filler is tabular.

7. The resin composition according to claim 6,
wherein an average particle diameter of the inorganic filler is 0.1 μm to 30 μm,
a thickness of the inorganic filler is 1 nm to 1000 nm, and
an aspect ratio of the inorganic filler is 2 to 100.

8. The resin composition according to claim 1, wherein an average particle diameter of the inorganic filler is 0.1 μm to 30 μm.

9. The resin composition according to claim 1, wherein a thickness of the inorganic filler is 1 nm to 1000 nm.

10. The resin composition according to claim 1, wherein an aspect ratio of the inorganic filler is 2 to 100.

11. The resin composition according to claim 1, wherein the inorganic filler is selected from boron nitride, aluminum nitride, silicon carbide, alumina, talc, metals, titanium oxide, barium titanate, calcium titanate, lead zirconate titanate, ferrite, magnesium hydroxide, antimony oxide, aluminum hydroxide, zinc borate, molybdic acid compounds, tin oxide compounds, phosphoric compounds, iron oxide, cuprous oxide, silica, hollow silica, and hollow glass.

12. The resin composition according to claim 1, wherein the inorganic filler includes a surface treatment layer.

13. The resin composition according to claim 12, wherein the surface treatment layer includes silane coupling agents, titanate coupling agents, phosphoric acid esters, and fatty acids.

14. The resin composition according to claim 1, wherein a melt tension at a temperature 20° C. higher than a melting point of the resin composition is 1.0 mN or more.

15. The resin composition according to claim 1, wherein a melt tension at a temperature 20° C. higher than a melting point of the resin composition is 1.0 mN to 7.0 mN.

16. The resin composition according to claim 1, wherein a melting point of the resin composition is 275° C. to 330° C.

17. A resin sheet comprising the resin composition according to claim 1.

18. A conductor-layer-included resin sheet comprising:
the resin sheet according to claim 17; and
a conductor layer adjoining at least one principal surface of the resin sheet.

19. A multilayer substrate comprising the conductor-layer-included resin sheet according to claim 18.

20. A method for manufacturing a resin sheet, the method comprising:
preparing a resin composition that includes (1) a resin component comprising a liquid crystal polymer as a primary component thereof and (2) an inorganic filler having a specific surface area of 30 m²/cm³ or less and a maximum diameter of 100 μm or less, wherein a content of the inorganic filler is 0.1% by volume to 60% by volume in the resin composition; and
molding the resin composition into a sheet by melt extrusion.
